(19) United States
(12) Patent Application Publication
(10) Pub. No.: US 2008/0259057 A1
(43) Pub. Date: Oct. 23, 2008

(54) Electronic Reading Device Mimicking a Reading experience of a Paper Document

(76) Inventor: Johannes Brons, Eindhoven (NL)

Correspondence Address: THORNE & HALAJIAN;APPLIED TECHNOLOGY CENTER, 111 WEST MAIN STREET, BAY SHORE, NY, 11706, US

(21) Appl. No.: 12/066,613

(22) PCT Filed: Aug. 31, 2006
(86) PCT No.: PCT/EP06/65887

§ 371 Date: Mar. 12, 2008

Related U.S. Application Data
(60) Provisional application No. 60/716,527, filed on Sep. 14, 2005.

(51) Int. Cl. G06F 3/048

(52) U.S. Cl. 345/184

(57) ABSTRACT

An apparatus comprises a display screen (DS) for visualizing digital information page by page, and a flip bar (FB) being movable upon user activation in at least two directions for flipping pages of the digital information back and forth, respectively. Such an apparatus may be an electronic reading device mimicking a reading experience of a paper document.

### FIELD OF THE INVENTION

The invention relates to an apparatus comprising a display screen for visualizing digital information page by page.

The invention is particularly useful in an electronic reading device which should mimic the reading experience of a paper document such as a book or newspaper.

### BACKGROUND OF THE INVENTION

Electronic content in the form of text and illustrations is increasingly available. While it is already feasible to read all our documents from our computer screens, we still prefer to read from paper prints. As a consequence, an increased amount of paper prints are generated, increasing inconvenience to consumers and increasing paper waste. Reading on an electronic device such as Laptop PC, PDA, mobile phone or e-reader has been an alternative for many years but people don't read with these devices for hours. Also various e-reading devices specifically designed for portable reading have been commercially available. These screens are usually based on liquid crystal displays (further also referred to as LCD) containing backlights and double glass plate. Reflective LCD has recently been used as the display screen for e-readers, but reading performance deviates largely from the real paper prints.

Only the Sony Librie e-reader, introduced in the market since April 2004, used a paper-like screen based on electrophoretic display, having identical reading performance as conventional paper prints: high readability, low power consumption, thin, and lightweight. The use of such paper-like display could bring a breakthrough in reading electronic content on an electronic reading device. To reach such a breakthrough, it is very important to create the same page-turning experience as reading a conventional book, i.e. simulating “page turning like a real paper book”. Without such a page turning experience, reading from an electronic display still remains “controlling an electronic device”.

In addition, digital content is very abstractive and not fitted to a visual standard as conventional paper products. Therefore, in an embodiment the electronic reading device should be able to indicate in a very simple, effective and visual way the place or page where a user is reading in a book, newspaper, magazine or document. Otherwise, a user would quickly lose track of the position/page in a reading document.

### SUMMARY OF THE INVENTION

It is an object of the invention to provide an electronic reading device which creates to the user the same page-turning experience as reading a conventional book.

A first aspect of the invention provides an apparatus as claimed in claim 1. Advantageous embodiments are defined in the dependent claims.

The apparatus in accordance with the first aspect of the invention comprises a display screen for visualizing digital information page by page, and a flip bar being movable upon user activation in at least two directions for flipping pages of the digital information back and forth, respectively. When the flip bar is moved in one of the at least two directions the display of the present page of the digital information on the display screen is changed into display of the next page of the digital information. When the flip bar is moved in the other one of the at least two directions the previous page of the digital information will be displayed. Thus, one and the same flip bar can be used to flip or turn pages of the digital information. In practice, the same hand or portion of a hand which is resting on the flip bar can easily be used to flip pages back and forth through the digital information. The portion of the hand may be one or more fingers. It is not required to have several separate buttons which often distract the user because he has to look whether his finger is touching the correct one of the buttons. Moreover, the activation of the flip bar much better mimics the flipping of pages of a paper book than the use of separate keys. The use of the flip bar is especially advantageous if the hand which is holding the apparatus is also used to control the flip bar.

In an embodiment, the flip bar is movable in two opposite directions. This is very user friendly because it fits the intuition of the user which also has to make opposite movements when flipping pages in a paper book.

In an embodiment, when the apparatus is held in a hand of the user and is oriented such that the user can read the digital information displayed on the display screen the two directions in which the flip bar is moveable are left and right. Again, this is very intuitive to the user because he has to make a movement very similar to reading a paper book. If the reader wants to read the next page he may move the flip bar to the left just like he has to flip a present page of a paper book to the left to be able to read the next page. When the flip bar is moved to the right, the previous page is displayed. However, if a user prefers, he may interchange this control in that a movement to the right provides the next page.

In an embodiment, the flip bar is positioned such that the user is able to put the thumb of the hand holding the apparatus on it. By holding the apparatus in the palm of the hand and having the thumb free to operate the flip bar a very easy manner of operation the flip bar is obtained.

In an embodiment, the flip bar is arranged at a side of the display screen DS, or said differently near an edge of the apparatus. This enables to operate the flip bar with the thumb or another finger without covering other buttons or the display. Further, the distance the finger of the same hand which is holding the apparatus has to reach for the flip bar is not too large to be able to operate the flip bar.

In an embodiment, the flip bar is an elongated key which minimizes the effort to carefully position the finger and does not require to look whether the finger is positioned correctly which would be required if the flip bar is a small key.

In an embodiment, the flip bar is arranged parallel to a side of the display screen. Again, this facilitates the positioning of the finger operating the flip bar. The user is looking to the screen which can be used as an orientation mark for the position of the flip bar because it is known that the flip bar extends parallel to an edge of the display screen. Further, usually, the housing of the apparatus will be designed such that its contours follow the contours of the display screen. Consequently, in fact the flip bar extends at least substantially in parallel to the edge of the housing which allows an easy positioning of the thumb above the flip bar for the thumb of the hand holding the apparatus.

In an embodiment, the flip bar is arranged at the longest side of the display screen to obtain the highest possible resemblance with flipping pages of a paper document.

In an embodiment, a single page is flipped when the flip bar is activated during a short time period smaller than a predetermined time period. With flipped is meant in the context of the electronic reader that the next or previous page of the document is displayed. A group of pages is flipped when the flip bar is activated longer than a predetermined period in time. In another embodiment, the speed of flipping through the pages increases the longer the flip bar is activated. Again, this is a very intuitive manner to control the page flipping.

In an embodiment, the flip bar is rotates around an axis parallel to a side of the display screen when activated. For example, if the flip bar is operated with the thumb, a movement of the thumb to the left causes a rotation to the left of the flip bar and a next page is displayed. But, of course a similar feel is obtained if the flip bar is shiftable from left to right or more in general away from and towards the display screen.

In an embodiment, the apparatus comprises at least one button to directly select application categories if the information to be displayed, such as for example: books, newspaper, user documents, and technical publications.

In an embodiment, the apparatus comprises at least one button to directly control the navigation through the displayed content. For example, this button or these buttons may be used to select items or hyperlinks in the displayed content. It must be possible to indicate that a particular selection should be activated, for example by activating a separate button indication the decision or selection.

In an embodiment, the apparatus comprises an i-connector for downloading content from a provider. The content comprises the document which has the pages to be displayed. The connector may be a slot for receiving a memory card, or a unit for connecting the apparatus wired or wireless to a network. For example, the network may be a local network or the internet.

The apparatus may comprise buttons for further functions such as for example, a mode/menu button for activation of a menu, and a level-up button for going up a level in the display hierarchy. For example, levels in the display hierarchy are: on the top level an indication or overview of the content of the document, on the next lower level a page of the document, or a sub-overview of for example a chapter of the document.

In an embodiment, the flip bar has a sensor which indicates where the flip bar is touched. This touch position on the flip bar can be used to control a position of a cursor on the displayed page. For example, the total length of the flip bar may be thought to correspond to the length of the display screen or the displayed page thereon. The relative position with respect to the top or bottom of the flip bar determines the relative position of the cursor with respect to the top or bottom of the display screen, respectively. The cursor needs not be visible and may only become visible upon touching the flip bar at a position corresponding to a hidden link of a series of links in the content displayed. By changing the touch position on the flip bar, the cursor shall move to the corresponding content item. By e.g. pressing the flip bar the corresponding content item can be selected and retrieved.

In an embodiment, a page indicator is displayed which represents, the total number of pages of the document, or a page number of the page of the document which is actually displayed. If the number of pages of the document is relatively large, it may not be possible to display a number for each page. Instead, a row of vertical lines is displayed which indicate a division of the document in blocks of pages. An indication is provided in this row of vertical lines to show the user where the page actually displayed is positioned in the document. The page indicator is refreshed when a page is flipped and/or when a user indicates with a stylus or pen a new page to be opened. In thick documents, such as for example books, the page numbers around the current page may become visible by zooming in a range of page numbers, for example by clicking the number of the current page on a touch panel of the display screen. For example, the previous 10 pages and the next 10 pages may be indicated with readable page numbers.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of an electronic reading device with a page flip bar,

FIG. 2 schematically shows an embodiment of an electronic reading device with a page flip bar with a sensor,

FIG. 3 schematically shows an embodiment of a graphical page indicator,

FIG. 4 shows an embodiment of the electronic reading device when hand hold, and

FIG. 5 shows a block diagram of the apparatus which is coupled to a content provider.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

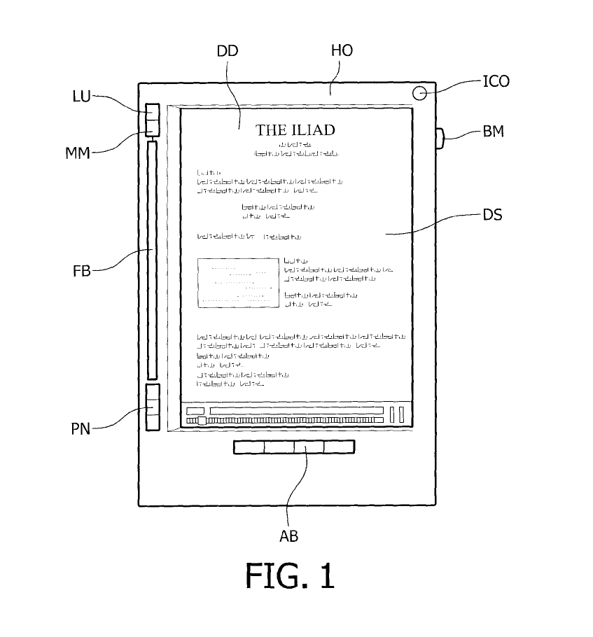

FIG. 1 schematically shows an embodiment of an electronic reading device with a page flip bar. The electronic reading device comprises a housing HO which holds a display device DD. The display device DD has a display screen DS for display of the information.

The page flip bar FB on the electronic reading device allows a user to operate the device with similar experience as reading a conventional paper book when turning a page. One may flick a book through the pages back and forth by moving the flip bar FB to left and right with e.g. one's thumb (e.g. in case of portrait usage mode). This would bring “paper like reading” experience to the user. To completely mimic this page turning, the flip bar FB is preferably arranged parallel to a side of the display screen DS, preferably to the longest side of the display, and rotates around an axes upon activation. The flip bar FB may be an elongated key along the display screen as illustrated in FIG. 1 on the left hand side of the display. The left-hand side is preferred as it is most intuitive for readers to turn with their left hand since this hand is used for non-coordinated handlings as the turning of the bar/page is. Alternatively, the flip bar FB may be positioned on the right hand side of the display.

The length f of the flip bar FB is similar to the length d of the display screen DS. To improve legibility, the lengths f and d are not indicated in FIG. 1 but in FIG. 3. The length f of the flip bar FB may be longer or shorter than the display side length d. The ratio of the length f of the flip bar FB and the length d of the display varies from 1.2 to 0.2, preferably between 0.8 and 0.2. The flip bar FB length f is preferably 0.75 of the page length d. But, the elongated key may not resemble a “normal” button or key, which is usually meant for pressing for activation. The interface can be used in landscape or portrait orientation. The length f of the flip bar FB gives the user some freedom in holding the device while still able to operate the interface comfortably.

When one holds the flip bar FB shortly (say 1 second), page-to-page turning can be realized. When one holds the flip bar FB with a prolonged time period (say >1 second), a group of pages may be turned by one motion and holding. For example, five pages may be turned in one motion by holding for a prolonged time period. The number of pages per-group-turning can be selected by a user in “settings”, with a preferred default number of 5 pages. The advantage of group-page to group-page turning is the high speed of obtaining desired page/content by skipping the visualization/display of many pages between. This is particular interesting in a device using e.g. electrophoretic display, which display has often limited refresh speed. It is also possible to have fast page-to-page turning upon the prolonged time period of holding on the flip bar FB. This means that holding the flip bar FB makes it possible to flip through the pages when one is searching for certain text. The speed of flipping through the pages may increase if the user holds it down longer. In this option, the refresh speed of the display has to be fast enough to satisfy the application.

The flip bar FB may also give an Audio feedback to the activation action: for example a bleep, a sound of turning a page, preferably a sound of turning a paper book, or “Click”. The sound may be switched off in e.g. settings by a user.

The e-reading device may further comprise buttons AB for application categories. These application categories may include different archives, e.g. My Books, My Newspapers or My Documents. These archives can quickly be accessed using the archive buttons AB located at e.g. the bottom of the device. Advanced search functions may be installed to locate the required content quickly.

The electronic reading device may further comprise page navigator buttons PN for content navigation. Reading with the flip bar FB is close to the nature of reading paper books, or magazines. It is preferred that selecting content segments/hyperlinks is done in a natural form (in particular when no touch screen or stylus). Therefore, the use of the page navigator will allow the user to go through the sections on a page and leave the stylus not used. The content may be navigated upon pressing/moving these buttons e.g. up (upper one) or down (lower one), decision (middle one). These buttons are in particular required when the device does not include a pen input/touch capability.

Bookmarks can be placed before one closes the content in order to quickly return to that point when one wants to continue reading. In order to further mimic the experience of reading a paper book, a temporary bookmark of a page of a book may be implemented. Such a bookmark enables a quick return to the “old” page where the user was reading from a different page where the user wants to take quick look/check to e.g. reference. This makes it similar to reading a paper book, where people often flick through the pages back and forth, e.g., for reference or re-reading of passages, while keeping a hand or finger on the page they were reading to be able to quickly return and resume reading. The bookmark may be made using one or more additional key/buttons or one or more of the above buttons. In case additional buttons need to be used, at a side of the display on the frame of the display a button (or any other touch sensitive area) may be provided. The user can press on the button to place a temporary marker on the presented page. After navigation through the document, the user releases the button and returns to the temporarily bookmarked page. Obviously, the user may simply want to ignore the temporary marker and continue on the page s/he has just navigated to. Therefore, a method must be provided to release the button without returning to the marked page.

Alternatively, returning to the marked page could be activated only in response to a special action, such as moving from the button onto the (touch sensitive) display. When the user simply releases the button, the temporary bookmark is ignored and removed so that the user stays on the page that is visible at that moment.

The button to place a temporary bookmark should be located such that the user can easily activate it and activate the ‘return to previous location’ function. It is therefore preferred that the button is located on the side of the display, close to where the finger(s) of the user are that hold the display. To further facilitate the browsing in the document, a button to temporarily mark the presented page can be provided at both sides of the display so that the user can choose which hand to use to hold on to the page and which hand to use to browse. Such a configuration furthermore offers the user the function to quickly jump between two pages, e.g., for comparison, each associated with one of the buttons.

The user can receive visual feedback on the fact that a temporary bookmark has been placed, i.e., that s/he is holding on to a particular page in the book. This can be done in many ways. For example, an outline of a hand can be drawn on top of the presented pages, or the visual effect of placing a hand in a book can be mimicked. The latter further presents implicit feedback to the user about the number of pages between the ‘hand’ (the temporary bookmark) and the presented page. For the former this can be done by fading the outline as more pages appear on top of the marked page.

The button for creating a bookmark can be a hard/mechanical button on the device frame but can also be a soft button or an icon on the display screen when a touch panel is attached on the display. When a soft button is implemented, one may place the book marks directly on a page via e.g. the page bar (page indicator) after the activation of the book mark button. A symbol, for example an arrow may be introduced for a specific page at the page bar and one can quickly view these pages by clicking these bookmarks.

This way of offering the user a way to hold on to a page and browse through the document at the same time is advantageous even if only one page is presented at a time. Although current electronic reading displays offer bookmarks, this is less accessible and therefore does not offer the ease of use of the proposed solution. Particularly the low-effort non-committal nature of the ‘hand between the pages’ is what makes this option powerful for paper books. The present solution is to come as close as possible to this affordance of regular paper books.

The electronic reading device may further comprise an i-connector ICO for e.g. connecting the device to e.g. a content server COS (see FIG. 5). The digital content may be transferred to the e-reader e.g. by inserting memory cards pre-loaded with the content, by connecting the e-reader to a PC where it makes itself available as a new drive or by directly connecting it to a content delivery system and/or a content center of a publisher or content retailer via the wired or wireless internet INT (see FIG. 5).

The electronic reading device may further comprise a button MM for mode/menu activation. Upon the activation of this button, a menu may appear showing, for example, a device menu: user settings, connectivity settings, drives (SD, MMC, USB, main memory) or a usage mode: printed media vs. audio/video and/or personal settings. The items can be selected by using the navigation buttons and/a stylus on a screen with touch panel.

The electronic reading device may further comprise a level-up button LU for going to a level higher than the current level. Assuming that one is reading a page of a book and wants to come back to the menu which is layer higher than the present page, one can come back to the menu level upon activating this button, regardless the page position where the user is reading.

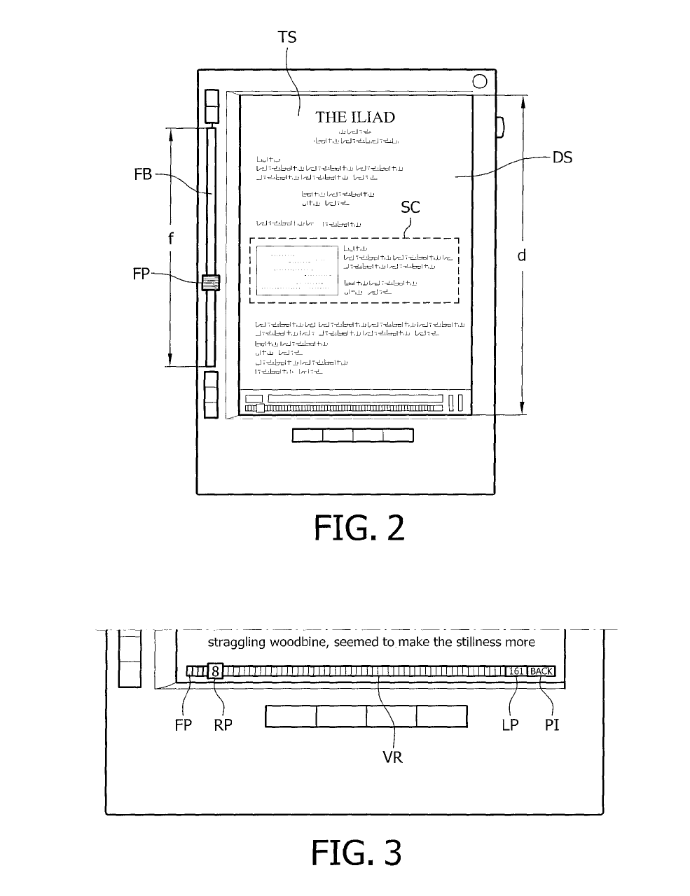

FIG. 2 schematically shows an embodiment of an electronic reading device with a page flip bar with a sensor.

The flip bar FB may further be fitted with a sensor FP to navigate through content on a display page. The length of the flip bar FB symbolizes the whole content (length) or all the links/sections/blocks SC on a display page, and the position determined by the sensor FP effectively controls the position of a cursor on the display page. The cursor needs not be visible and only becomes visible upon touching the flip bar at a position corresponding to a hidden link of a series of links in the content displayed. By changing the touch position on the flip bar, the cursor shall move to the corresponding content item. The corresponding content item can be selected and retrieved, for example by pressing the flip bar. Thus if the user taps with his or her finger at the top of the flip bar FB, the first link will be highlighted. So every position on the flip bar FB confers to a position in a list of links or content on the display, in particular in the vertical direction.

FIG. 3 schematically shows an embodiment of a graphical page indicator. The representation of the number of pages, indicating the “thickness” of a digital document may be implemented on the display screen by introducing a page-indicator PI, for example at the bottom or top of the display screen DS. In the example in FIG. 3, this page-indicator is positioned at the bottom of the display. To make the experience clear to the user and to indicate where the user is reading in the content, the page-indicator, to be displayed on the screen, may be designed as graphic striving to mimic the experience of a paper book, newspaper and the like as closely as possible to give the user a real sense of orientation in the content. Therefore the rectangle RP containing the number of the page where the user is reading (the number “8” in FIG. 3) resembles a paper page. The page-indicator can be refreshed with page turning and can also be controlled by a stylus/pen. The number “1” indicates the start page FP of a digital document, e.g. book, and the number “151” indicates the last page LP of the digital document.

If the digital content is too “thick” and the number of book or newspaper pages is too large to be displayed as individual page numbers, vertical lines VR may be used for indicating the “thickness”. The vertical lines VR are arranged in a row. In the example shown in FIG. 3, the vertical lines are interconnected by horizontal lines to obtain small rectangles which indicate a group of pages. The group wherein the page resides which is displayed is marked such that the reader gets information where the actual page resides in the document. The marking may be of any kind, for example, the block may be highlighted, shaded, colored, or the number of the page which is displayed may be shown as indicated in the rectangle RP.

A particular number of page number indicating where the user is reading will be refreshed and displayed on the page indicator upon page turning. The last page of the content is indicated, preferably with a digit.

In thick documents such as for example books, the page numbers around the current page may become visible by zooming in a range of page numbers, for example by clicking the number block of the current page when the display screen is integrated with a touch panel. For example, the previous 10 pages and the next 10 pages may be indicated with readable page numbers.

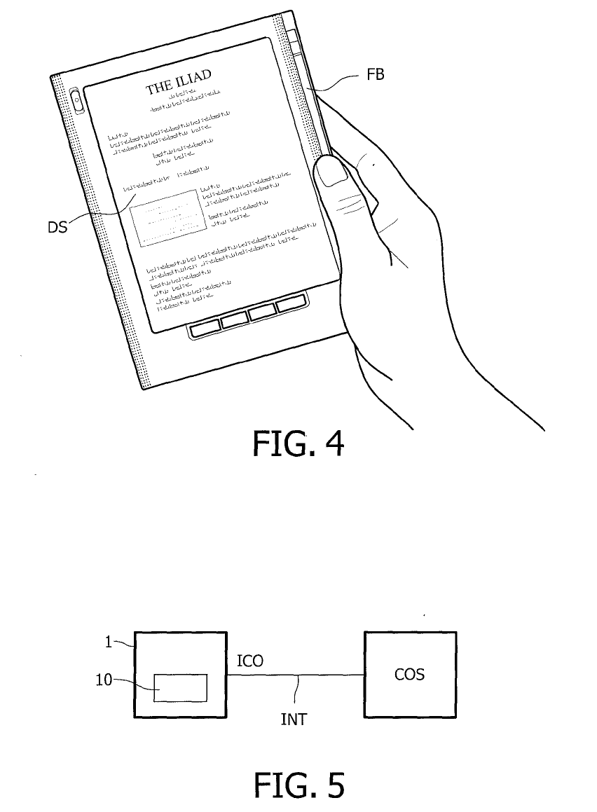

FIG. 4 shows an embodiment of the electronic reading device. This Figure shows an example how a person holds the electronic device in his or her hand such that the information displayed on the display screen DS is readable by (or said differently has the intended orientation with respect to) the user. The flip bar FP is operated with the thumb by pushing the flip bar FP from the default middle position to either the right or the left.

The e-reading device may further comprise a touch sensor (behind or in the front of the display), allowing easy navigation in the content and/or making handwritten notes in the content or drawing images to explain or store user's ideas. This also gives the user the opportunity to read content in a more productive fashion.

This invention is applicable to any electronic device/apparatus for retrieving and visualizing digital content (text, graphics), in particular to devices using bi-stable displays based on LCD and electrophoretic displays.

FIG. 5 shows a block diagram of the apparatus which is coupled to a content delivery system and/or a content center of a publisher or content retailer via the wired or wireless Internet INT. The electronic reading device 1 comprises an i-connector ICO for downloading content directly from a content provider or via a content delivery system in which the content may be personally stored and downloaded from a content provider. The content comprises the document which has the pages to be displayed. And the document may be present on a content server COS. The connector ICO may be a slot for receiving a memory card, or a unit for connecting the apparatus wired or wireless to a network. For example, the network may be a local network or the internet INT.

The electronic reading device 1 may comprise a camera and/or audio player and/or video player. For example, the audio player may be an MP3 player, the video player may be a (mini) DVD player.

It should be noted that the above-mentioned embodiments illustrate rather than limit the invention, and that those skilled in the art will be able to design many alternative embodiments without departing from the scope of the appended claims.

For example, if a multiple amount of buttons is mentioned to control a particular function, this may actually be separate (push) buttons. Alternatively, the functions may be completely combined in a single button such as for example a button which has a default position, which can flip in two directions and which can be depressed. Also other combinations of buttons having two or more positions may be used.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An apparatus comprising
a user interface and an input (ICO) for retrieving digital information,
a display screen (DS) for visualizing the digital information page by page, and
a flip bar (FB) being movable upon user activation in at least two directions for flipping pages of the digital information back and forth, respectively.

2. An apparatus for retrieving and visualizing information as claimed in claim 1 further comprising attached electronics, software and mechanics.

3. An apparatus according to claim 1, wherein the flip bar (FB) is moveable in two opposite directions for flipping the pages of the digital information back and forth to provide a paper like reading experience to the user.

4. An apparatus according to claim 3, wherein the flip bar (FB) is moveable to left and right when the apparatus is oriented such that the digital information is readable by a user.

5. An apparatus according to claim 4, wherein the flip bar (FB) is positioned to enable the user to position the thumb of a hand holding the apparatus on it.

6. An apparatus according to claim 1, wherein the flip bar (FB) is arranged at a side of the display screen (DS).

7. An apparatus according to claim 1, wherein the flip bar (FB) is an elongated key.

8. An apparatus according to claim 7, wherein the flip bar (FB) is arranged parallel to a side of the display screen (DS).

9. An apparatus according to claim 1, wherein the flip bar (FB) is arranged along a longest side of the display screen (DS).

10. An apparatus according to claim 8, wherein the flip bar (FB) is arranged on a left hand side of the display screen when the apparatus is oriented such that text of the digital information is readable by a user.

11. An apparatus according to claim 8, wherein the flip bar (FB) has a length ratio in a range from 1.2 to 0.2 between a length (f) of the flip bar (FB) and a length (d) of the side of the display screen (DS) to which the flip bar (FB) is arranged in parallel.

12. An apparatus according to claim 11, wherein the length ratio is selected between 0.8 and 0.2.

13. An apparatus according to claim 11, wherein the wherein the length ratio is selected to be larger than 0.75.

14. An apparatus according to claim 1, being constructed for flipping one page when the flip bar (FB) is activated one time.

15. An apparatus according to claim 14, being constructed for flipping one page when the flip bar (FB) is activated during a period in time shorter than 1 second.

16. An apparatus according to claim 1, being constructed for flipping a group of pages when the flip bar (FB) is one time activated longer than a predetermined prolonged time period.

17. An apparatus according to claim 16, being constructed for flipping the group of pages when the flip bar (FB) is one time activated longer than 1.5 second.

18. An apparatus according to claim 16, wherein a number of pages in a group is 5.

19. An apparatus according to claim 16, wherein number of pages in a group is set by a user.

20. An apparatus according to claim 1, being constructed for continuing flipping of the pages upon activating the flip bar (FB) and wherein a speed of flipping through the pages increases the longer the flip bar (FB) is activated.

21. An apparatus according to claim 16, wherein the flip bar (FB) is activated by moving the flip bar (FB) in the at least one direction and pressing down the flip bar (FB).

22. An apparatus according to claim 1, being constructed for giving an audio feedback upon activating the flip bar (FB).

23. An apparatus according to claim 22, wherein the audio feedback is a bleep, a sound of turning a page of a paper book, or a click.

24. An apparatus according to claim 1, wherein the flip bar (FB) is constructed for rotating around an axis parallel to a side of the display screen (DS) upon activation.

25. An apparatus according to claim 1, wherein the flip bar (FB) is constructed for shifting away from and towards the display screen (DS).

26. An apparatus according to claim 1, further comprising at least one button (AB) for selecting an application category.

27. An apparatus according to claim 1, further comprising at least two buttons (AB) for selecting different application categories.

28. An apparatus according to claim 27, wherein the different application categories include Books and Newspapers and/or Documents.

29. An apparatus according to claim 1, further comprising page-navigator buttons (PN) for content navigation for selecting content sections (SC) and/or hyperlinks of a page being displayed.

30. An apparatus according to claim 29, comprising three page navigator buttons (PN), two for navigating up and down, respectively, through sections (SC) of the page being displayed, and one for indicating a decision or selection.

31. An apparatus according to claim 1, further comprising an i-connector (ICO) for downloading content from a content provider.

32. An apparatus according to claim 31, wherein the i-connector (ICO) is constructed for connecting the apparatus to a content server (COS) to download content from a content provider.

33. An apparatus according to claim 1, wherein the i-connector (ICO) is constructed for connecting the device to a content server via internet (INT).

34. An apparatus according to claim 1, further comprising a button (MM) for mode/menu activation for displaying a menu.

35. An apparatus according to claim 34, wherein the menu shows usage modes.

36. An apparatus according to claim 35, wherein the usage modes comprise: printed media, audio/video, and/or personal settings.

37. An apparatus according to claim 1, further comprising a level-up button (LU) for going to a level higher than the current level.

38. An apparatus according to claim 1, wherein the flip bar (FB) is fitted with a sensor (FP) to navigate through content on a display page being displayed on the display screen (DS).

39. An apparatus according to claim 38, wherein a length of the flip bar (FP) symbolizes the whole content length of a display page, or all the links/sections/blocks on a display page, and wherein the sensor (FP) registers a position at which the flip bar (FP) is touched for controlling a position of a cursor on the display page.

40. An apparatus according to claim 39, wherein the cursor is one link in a series of links hidden in the content displayed on the display screen (DS).

41. An apparatus according to claim 1, being constructed for displaying a page-indicator (PI) on the display screen (DS) being related to a number of a page of a digital document.

42. An apparatus according to claim 41, being constructed for displaying the page-indicator (PI) representing a number of pages (LP) of a digital document, the number of pages (LP) indicating a thickness of the digital document.

43. An apparatus according to claim 41, being constructed for displaying the page-indicator (PI) representing a page number of the page being displayed on the display screen (DS).

44. An apparatus according to claim 41, being constructed for displaying the page-indicator (PI) to display a row of vertical lines at a bottom of the display screen (DS) when the display screen (DS) is oriented such that a user can read the information displayed, wherein the row of vertical lines indicates the thickness of the digital document.

45. An apparatus according to any one of the claims 41, being constructed for refreshing the page-indicator (PI) with page turning and/or is controllable by a stylus/pen.

46. An apparatus according to claim 1, further comprising a touch sensor (TS) associated with the display screen (DS).

47. An apparatus according to claim 1, wherein the display screen (DS) is a bi-stable display based on LCD and/or electrophoretic displays.

48. An apparatus according to claim 1, wherein a player (10) is included.

49. An apparatus according to claim 1, wherein a CD player (10) is included.

50. An apparatus according to claim 1 being an electronic reading device.
